(19) United States
(12) Patent Application Publication
(10) Pub. No.: US 2014/0020227 A1
(43) Pub. Date: Jan. 23, 2014

(54) BNC CONNECTOR NUT GRIPPER/DRIVER

(71) Applicants: Larry Thomas Auchoberry, Carson City, NV (US); Mark Stephen Dieter, Gardnerville, NV (US)

(72) Inventors: Larry Thomas Auchoberry, Carson City, NV (US); Mark Stephen Dieter, Gardnerville, NV (US)

(73) Assignee: General Electric Company, Schenectady, NY (US)

(21) Appl. No.: 13/550,635

(22) Filed: Jul. 17, 2012

(51) Int. Cl. B25B 13/48; B23P 11/00

(52) U.S. Cl. 29/456; 81/125; 29/428

(57) ABSTRACT

A socket assembly can attach a fastener to a receiving structure. The socket assembly includes a body portion defining a receiving space. The socket assembly further includes a gripping structure attached to the body portion. The gripping structure movably supports the fastener within the receiving space. The gripping structure is movable between a closed position and an opened position. The socket assembly further includes an alignment structure axially aligning the body portion and the receiving structure. Methods of attaching a fastener to a receiving structure are also provided.

### BACKGROUND OF THE INVENTION

1. Field of the Invention

The present invention relates generally to socket assemblies, and more particularly, to a socket assembly for attaching a fastener to a receiving structure.

2. Discussion of the Prior Art

Connectors (e.g., Bayonet Neill-Concelman “BNC” connectors, etc.) and fasteners (e.g., nuts, etc.) are known and used in many different applications. Threading a fastener onto a connector can be difficult and time consuming because the fastener and connector are relatively small. In one approach, assemblers use their hands and/or pliers to pick up and install the fasteners onto the connectors. This operation can be inefficient, tedious, and slow. In another approach, assemblers use standard socket assemblies to thread fasteners onto the connectors. The standard socket assemblies were also difficult to use and time consuming, as the standard socket assemblies were too large to accommodate for the relatively small fasteners. The fastener often became misaligned on the connector, leading to cross-threading. It would be useful to provide a socket assembly that can relatively easily pick up a fastener and thread the fastener onto a connector with minimal risk of misalignment, cross-threading, etc.

### BRIEF DESCRIPTION OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect, a socket assembly for attaching a fastener to a receiving structure is provided. The socket assembly includes a body portion defining a receiving space. The socket assembly further includes a gripping structure attached to the body portion. The gripping structure movably supports the fastener within the receiving space. The socket assembly further includes an alignment structure for axially aligning the body portion and the receiving structure.

In accordance with another aspect, a socket assembly for attaching a fastener to a receiving structure is provided. The socket assembly includes a body portion defining a receiving space. The socket assembly further includes a gripping structure movably supported by the body portion. The gripping structure is movable between a closed position and an opened position in which an end of the gripping structure is radially spaced away from the receiving space. The gripping structure supports the fastener within the receiving space.

In accordance with another aspect, a method of attaching a fastener to a receiving structure is provided. The method includes the step of gripping the fastener with a socket assembly. The method further includes the step of axially aligning the socket assembly and the receiving structure by displacing an alignment structure of the socket assembly axially in a first direction as the socket assembly moves towards the receiving structure in an opposing second direction. The method also includes the step of releasing the fastener from the socket assembly onto the receiving structure.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is a schematized perspective view of an example attachment apparatus including an example drill and socket assembly and an example receiving structure in accordance with an aspect of the present invention;

FIG. 2 is an exploded, schematized perspective view of the example socket assembly of FIG. 1 in accordance with an aspect of the present invention;

FIG. 3 is a perspective view of the example socket assembly including an example gripping structure in a closed position;

FIG. 4 is a perspective view of the example socket assembly including the gripping structure in an opened position;

FIG. 5 is a cross-sectional view of the example socket assembly and receiving structure along line 5-5 of FIG. 1;

FIG. 6 is a cross-sectional view of the example socket assembly of FIG. 5 engaging the receiving structure; and

FIG. 7 is a cross-sectional view of the example socket assembly of FIG. 5 engaging the receiving structure and threading a fastener onto the receiving structure.

### DETAILED DESCRIPTION OF THE INVENTION

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

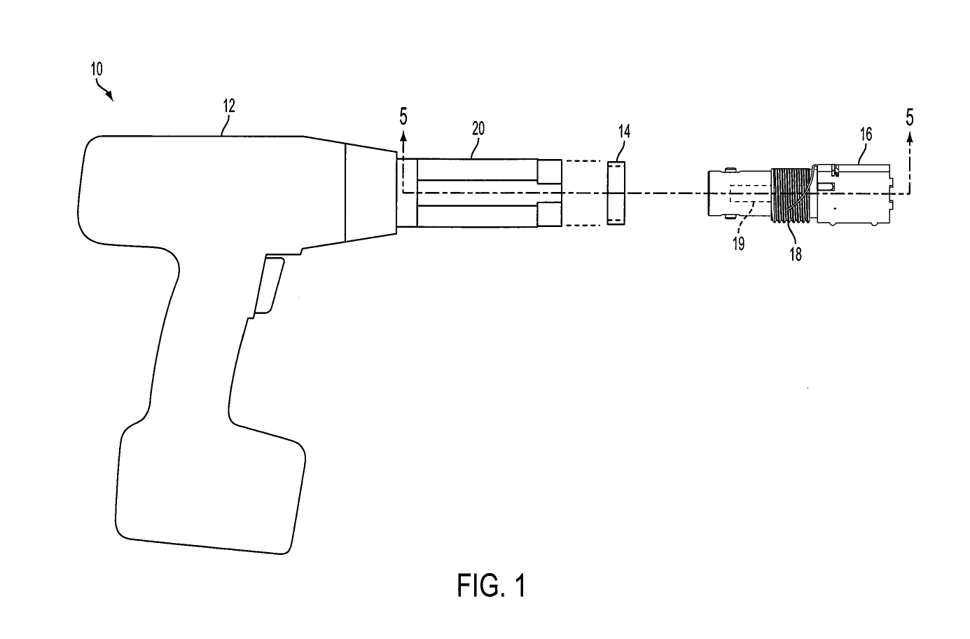

FIG. 1 schematically illustrates an example attachment apparatus 10 for attaching a fastener 14 to a receiving structure 16, such as a BNC connector or other similar connector. In short summary, the socket assembly 20 can be rotatably attached to a power tool, such as a drill 12. The socket assembly 20, while holding the fastener 14, can be axially aligned with the receiving structure 16. The socket assembly 20 is rotated, such that the fastener 14 is threaded onto the receiving structure 16. Accordingly, the socket assembly 20 can provide for attachment of the fastener 14 to the receiving structure 16 without the need for manual manipulation by an assembler.

Turning to the specific example shown in FIG. 1, the attachment apparatus 10 can include the drill 12. The drill 12 is somewhat generically/schematically shown in FIG. 1 to convey the concept that the drill 12 can include a number of different structures. For example, the drill 12 can include electric drills, pneumatic drills, cordless drills, etc. Further, as is generally known, the drill 12 outputs rotational movement for rotating the socket assembly 20.

The attachment apparatus 10 further includes the fastener 14. As will be described in more detail below, the socket assembly 20 can support (e.g., grip, hold, etc.) the fastener 14. The fastener 14 is somewhat generically/schematically depicted herein, and could include any number of structures. For example, the fastener 14 could include nuts, bolts, etc. In further examples, the fastener 14 is threaded, such as internally threaded. In the shown examples, the fastener 14 can include a hex nut, such as an internally threaded 9/16″ hex nut. The fastener 14 is not limited to such a size or shape, however.

The attachment apparatus 10 further includes the receiving structure 16. The receiving structure 16 is somewhat generically/schematically depicted in FIG. 1, as it is understood that the receiving structure 16 includes a number of different structures. In the shown example, the receiving structure 16 includes a BNC connector, though other types of connectors are envisioned. The receiving structure 16 includes a threaded portion 18. The threaded portion 18 extends along an outer surface of the receiving structure 16. The threaded portion 18 can extend along a longer or shorter axial length along the receiving structure 16 than as shown. The receiving structure 16 can further include a center portion 19 (shown in phantom in FIG. 1 as the center portion 19 is normally not visible in such a view). The center portion 19 can extend axially within the receiving structure 16.

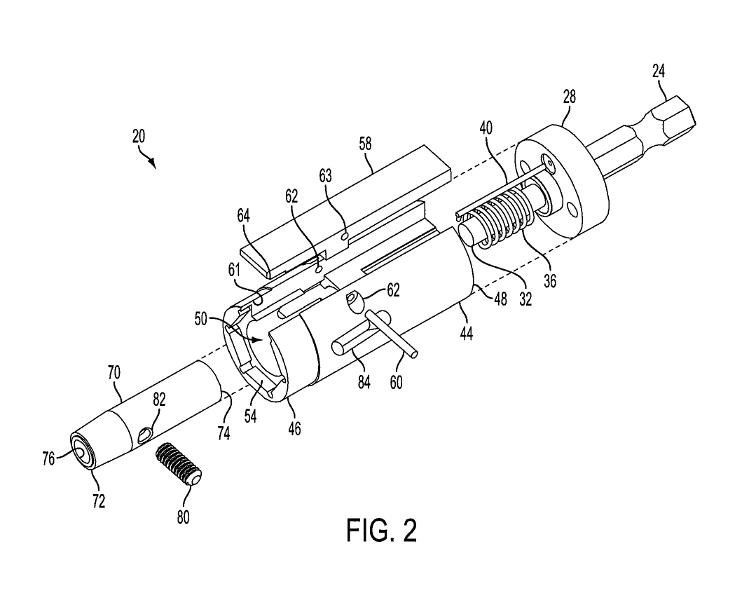

Referring now to FIG. 2, the socket assembly 20 is explained in more detail. It is to be appreciated that the socket assembly 20 in FIG. 2 is depicted in an exploded state for illustrative purposes and to more clearly depict internal components of the socket assembly 20. However, in operation, the socket assembly 20 is fully assembled similar to that shown in FIG. 1.

The socket assembly 20 includes a shank portion 24. The shank portion 24 forms the portion of the socket assembly 20 that is held by the drill 12. In one example, the shank portion 24 is received by the drill 12, such that the drill 12 can hold and rotate the socket assembly 20. The shank portion 24 can be held by a chuck (not shown) of the drill 12. In the shown example, the shank portion 24 includes a hex shape, though any number of sizes and shapes are envisioned, including a variety of polygonal shapes. As such, drill 12 can grip and rotate the shank portion 24, thus causing the socket assembly 20 to rotate about its longitudinal central axis. The shank portion 24 can also be selectively removed from the drill 12.

The socket assembly 20 can further include an end portion 28. The end portion 28 is attached to the shank portion 24. In particular, the shank portion 24 extends along the longitudinal central axis in a direction away from the end portion 28. In the shown example, the end portion 28 includes a substantially cylindrical shape, though other shapes are envisioned (e.g., square, oval, etc.). The end portion 28 can be integrally formed with the shank portion 24 (i.e., one piece formed) or, in further examples, could be fixed to the shank portion 24.

The socket assembly 20 can further include an arrangement portion 32. The arrangement portion 32 is attached to the end portion 28. The arrangement portion 32 extends along the longitudinal central axis in a direction away from the end portion 28. In the shown example, the arrangement portion 32 extends away from the end portion 28 on an opposite side from the shank portion 24. As such, the arrangement portion 32 is positioned on a first side of the end portion 28 while the shank portion 24 is positioned on an opposing second side of the end portion 28. The arrangement portion 32 can include a substantially cylindrically shaped structure, though other shapes are envisioned (e.g., square shaped cross-section, oval shaped cross-section, etc.). The arrangement portion 32 can be integrally formed with the end portion 28 (i.e., one piece formed) or, in further examples, could be attached to the end portion 28. In a fully assembled state, the arrangement portion 32 extends axially within the socket assembly 20.

The socket assembly 20 can further include at least one biasing device. The at least one biasing device includes an alignment biasing device 36. The alignment biasing device 36, includes a compression spring that wraps around the arrangement portion 32 and extends axially along the arrangement portion 32. The alignment biasing device 36 can extend a longer or shorter distance than as shown, and may include a varying elasticity range (e.g., stiff, flexible, etc.). The alignment biasing device 36 engages and contacts the end portion 28 at one end of the alignment biasing device 36. Accordingly, as the alignment biasing device 36 is compressed, the alignment biasing device 36 contacts the end portion 28 and is limited from further axial translation.

The at least one biasing device of the socket assembly 20 can further include a grip biasing device 40 for providing a biasing force within the socket assembly 20. The grip biasing device 40 includes a number of elastic biasing devices, including, but not limited to, compression springs, axially extending springs, spring pins, etc. In the shown example, the grip biasing device 40 includes a compressible spring pin. The grip biasing device 40 can extend axially along a direction that is generally parallel to the arrangement portion 32. In one example, the grip biasing device 40 is spaced apart a distance from the arrangement portion 32 such that the alignment biasing device 36 is positioned at least partially between the grip biasing device 40 and the arrangement portion 32. It is to be appreciated that in further examples, the grip biasing device 40 can extend a longer or shorter distance than as shown.

Referring still to FIG. 2, the socket assembly 20 further includes a body portion 44. The body portion 44 defines a substantially cylindrically shaped structure extending between a first end 46 and an opposing second end 48. The body portion 44 includes a generally hollow internal bore 50. The body portion 44 and/or the internal bore 50 are not limited to the cylindrically shaped structure as shown, and in further examples, includes a square shape, rectangular shape, oval shape, etc. In an assembled state, the body portion 44 is attached at the second end 48 to the end portion 28. In particular, the body portion 44 can have a cross-sectional size (e.g., diameter in the shown example) that matches or is larger than a cross-sectional size (e.g., diameter in the shown example) of the end portion 28. As such, the end portion 28 can cover the second end 48 of the body portion 44. The body portion 44 and end portion 28 can be attached in any number of ways, such as by mechanical fasteners (e.g., screws, bolts, etc.), welding, adhesives, threading, or the like. Accordingly, the arrangement portion 32, alignment biasing device 36, and grip biasing device 40 can each extend within the internal bore 50 of the body portion 44.

The body portion 44 further defines a receiving space 54. The receiving space 54 is positioned at the first end 46 of the body portion 44 opposite from the end portion 28. The receiving space 54 defines a substantially hollow, open space for receiving the fastener 14. In particular, the receiving space 54 extends axially from the first end 46 of the body portion 44 into an interior of the body portion 44. In the shown example, the receiving space 54 has a generally hexagonal shape that matches the hexagonal shape of the fastener 14. In the shown example, the receiving space 54 can receive the fastener 14 and, due to the matching shapes, limit rotation of the fastener 14 with respect to the receiving space 54. Of course, in further examples, other shapes are envisioned that can match the shape of the fastener 14 (e.g., receiving space 54 having a square shaped cross-section, oval shaped cross-section, etc.). The receiving space 54 can have slightly larger dimensions than the fastener 14, such that the fastener 14 can be received by and held within the receiving space 54. In one example, the receiving space 54 has an axial depth that is slightly less than an axial depth of the fastener 14, such that the fastener 14 can protrude at least partially from the first end 46 of the body portion 44 and out of the receiving space 54.

The socket assembly 20 further includes a gripping structure 58. The gripping structure 58 is attached to the body portion 44 of the socket assembly 20. In particular, the gripping structure 58 can be received within a slot 61 that extends axially along an outer surface of the body portion 44. In the shown example, the gripping structure 58 extends axially along the body portion 44 from the first end 46 to the second end 48 and defines an outer surface of the body portion 44. In further examples, however, the gripping structure 58 can extend a shorter distance than as shown, such as by not extending completely to the second end 48.

The gripping structure 58 is movably attached to the body portion 44 such that the gripping structure 58 moves or pivots with respect to the body portion 44. The gripping structure 58 can be attached to the body portion 44 in any number of ways. In the shown example, the gripping structure 58 can include a hinge pin 60 for attaching the gripping structure 58 to the body portion 44. The hinge pin 60 can extend through the body portion 44 and through the gripping structure 58. The hinge pin 60 can, for example, pass through a first hinge opening 62 formed in the body portion 44 and a second hinge opening 63 in the gripping structure 58. The hinge pin 60 can therefore extend in a direction that is generally transverse to the direction along which the body portion 44 and gripping structure 58 extend. It is to be appreciated that the gripping structure 58 is not limited to being movably attached to the body portion 44 with the hinge pin 60, and in further examples, could be attached in any number of ways, such as with other mechanical fasteners, snap fit means, etc.

The gripping structure 58 contacts and engages the grip biasing device 40. In one example, an end of the grip biasing device 40 contacts the gripping structure 58. The gripping structure 58 can therefore be biased to a closed or gripping position by the grip biasing device 40. The gripping structure 58 can be moved so as to overcome the elasticity of the grip biasing device 40, however. As such, the gripping structure 58 can be moved to an opened or non-gripping position while still remaining biased towards the closed position.

The gripping structure 58 can further include a tapered end portion 64. The tapered end portion 64 is disposed at an end of the gripping structure 58 that is adjacent the first end 46 of the body portion 44. The tapered end portion 64 can extend at least partially into the receiving space 54. As such, when the fastener 14 is positioned within the receiving space 54, the tapered end portion 64 can engage and grip the fastener 14, thus reducing the likelihood of the fastener 14 inadvertently being removed from the receiving space 54 and the longitudinal central axis. In addition, since the tapered end portion 64 gradually reduces in thickness towards the end of the gripping structure 58, the tapered end portion 64 can engage the fastener 14, whereupon the fastener 14 can move the end of the gripping structure 58 radially outwardly (i.e., in a direction away from the longitudinal central axis of the receiving space 54).

Referring still to FIG. 2, the socket assembly 20 further includes an alignment structure 70. The alignment structure 70 axially aligns the body portion 44 with the receiving structure 16. The alignment structure 70 includes a cylindrically shaped structure extending axially within the internal bore 50 of the body portion 44. The alignment structure 70 is not limited to the size and shape that is shown in FIG. 2, and in further examples, could include a square shaped cross-section, or the like. The alignment structure 70 extends between a first end 72 and an opposed second end 74. In one example, the first end 72 of the alignment structure can be tapered.

The alignment structure 70 includes an alignment opening 76. The alignment opening 76 is an elongated slot that extends axially through the alignment structure 70 from the first end 72 to the second end 74. The alignment opening 76 can have a generally circular cross-sectional shape, though other shapes are envisioned. The alignment opening 76 has a cross-sectional width (e.g., diameter in the shown example) that is slightly larger than a cross-sectional width (e.g., diameter) of the arrangement portion 32. Accordingly, in a fully assembled state, the alignment opening 76 can receive at least a portion of the arrangement portion 32 therewithin, such that the alignment structure 70 and arrangement portion 32 are coaxial. The alignment opening 76 allows the alignment structure 70 to translate axially along the arrangement portion 32. The alignment structure 70 can translate in a direction towards and away from the end portion 28. In addition, the alignment structure 70 can have an outer diameter that is slightly smaller than an inner diameter of the receiving structure 16. As such, the alignment structure 70 can be received and held within the receiving structure 16 such that the alignment structure 70 and receiving structure 16 are coaxially aligned.

The alignment structure 70 can engage the alignment biasing device 36. In particular, the second end 74 of the alignment structure 70 contacts and engages the alignment biasing device 36 as the alignment opening 76 receives the arrangement portion 32. The alignment biasing device 36 biases the alignment structure 70 to an extended position. However, the alignment structure 70 can translate along the arrangement portion 32, with the alignment biasing device 36 compressing and continuing to bias the alignment structure 70 towards the extended position.

The alignment structure 70 is movably attached with respect to the body portion 44. In particular, the alignment structure 70 can move (e.g., translate) with respect to the body portion 44. In the shown example, the alignment structure 70 includes an alignment screw 80. The alignment screw 80 can extend radially into the alignment structure 70. The alignment structure 70 can include a screw opening 82 for receiving the alignment screw 80. The screw opening 82 can receive the alignment screw 80, such that the alignment screw 80 protrudes at least partially into and out of the screw opening 82. In one example, the alignment screw 80 and screw opening 82 can each be threaded, such that a threading attachment between the alignment screw 80 and screw opening 82 can be achieved. However, the alignment screw 80 need not be limited to a threading attachment, and could be attached with respect to the alignment structure 70 in any number of ways.

The alignment screw 80 can protrude from the screw opening 82 and be received by an alignment slot 84 formed in the body portion 44. In one example, the alignment slot 84 extends through the body portion 44 from the internal bore 50 to an outer surface of the body portion 44. The alignment slot 84 extends axially along the body portion 44. As such, the alignment slot 84 can receive the alignment screw 80 and allow for axial translation of the alignment structure 70 with respect to the body portion 44. The alignment screw 80 can therefore translate within the alignment slot 84. It is to be appreciated that the alignment slot 84 can include one or more alignment slots. For example, the alignment slot 84 can include one alignment slot positioned to extend along the body portion 44. In another example, the alignment slot 84 can include a plurality of alignment slots, such as by having one alignment slot positioned on one side of the body portion 44 and another alignment slot positioned on an opposing side of the body portion 44.

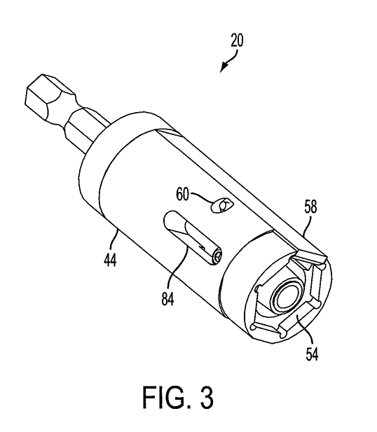

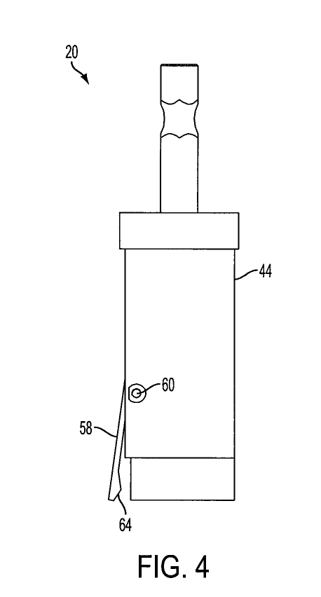

Referring now to FIGS. 3 and 4, the movement of the gripping structure 58 can be described in more detail. Initially, in FIG. 3, the gripping structure 58 can be in the closed position. While in the closed position, the gripping structure 58 is biased by the grip biasing device 40 to remain in the closed position.

Next, as shown in FIG. 4, the gripping structure 58 can be moved to the opened position. In one example, the gripping structure 58 rotates about the hinge pin 60 between the closed position (FIG. 3) and the opened position (FIG. 4). As shown, the tapered end portion 64 can include a slightly rounded shape towards an end of the gripping structure 58. The tapered end portion 64 can therefore contact the fastener 14. Due to the rounded shape of the tapered end portion 64, the fastener 14 can engage the tapered end portion 64 and cause the gripping structure 58 to move towards the opened position. Additionally, since the gripping structure 58 is biased by the grip biasing device 40 towards the closed position, the gripping structure 58 can exert a radial force onto the fastener 14 when the fastener 14 is positioned within the receiving space 54. As such, the gripping structure 58 can remain in the opened position and grip the fastener 14, thus minimizing the risk of the fastener 14 inadvertently being removed from the receiving space 54. The gripping structure 58 can therefore movably support (e.g., grip) the fastener 14 within the receiving space 54. For example, the gripping structure 58 can support the fastener 14, while allowing the fastener 14 to be selectively removed from the receiving space 54, thus providing removable support. In the opened position, the tapered end portion 64 can be radially spaced away from the receiving space 54.

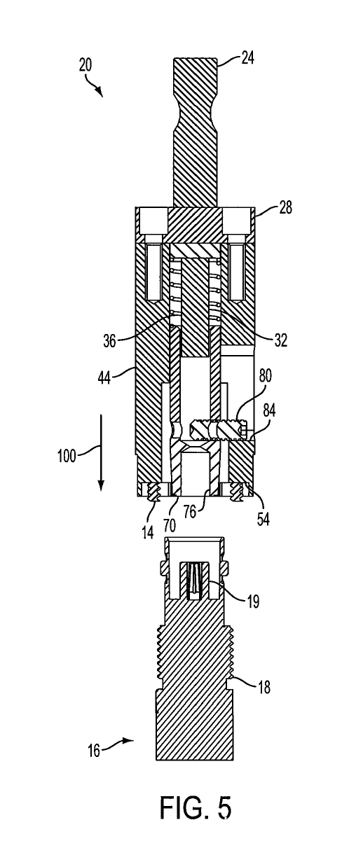

Referring now to FIGS. 5 to 7, the engagement of the socket assembly 20 and the receiving structure 16 can be described in more detail. FIGS. 5 to 7 depict a sectional view along line 5-5 of FIG. 1. It is noted that FIGS. 5 to 7 do not depict the drill 12 for illustrative purposes and to more clearly show the socket assembly 20. However, in a fully assembled state (similar to FIG. 1), the drill 12 can be included. Further, the drill 12 can rotatably support the shank portion 24 of the socket assembly 20.

Referring first to FIG. 5, the socket assembly 20 can initially be spaced apart from the receiving structure 16. The socket assembly 20 can include the fastener 14 positioned within the receiving space 54 of the body portion 44. In particular, the socket assembly 20 can grip the fastener 14. The fastener 14, though somewhat generically depicted, can include an internal threaded portion and can protrude at least slightly out of the receiving space 54. The socket assembly 20 is moved closer in proximity to the receiving structure 16 by moving along a first direction 100. In this example, the alignment structure 70 is initially in an extended position.

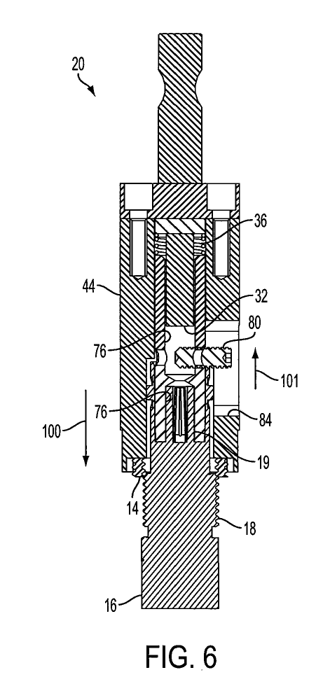

Referring now to FIG. 6, the socket assembly 20 can engage the receiving structure 16. In this example, the center portion 19 of the receiving structure 16 is received within the alignment opening 76. By engaging the alignment structure 70 with the receiving structure 16, the alignment structure 70 can translate and move axially within the body portion 44. In particular, the alignment structure 70 can move axially and cause the alignment biasing device 36 to compress. In this example, the socket assembly 20 is axially aligned with the receiving structure 16 due to the displacement of the alignment structure 70. The alignment structure 70 can move in a second direction 101 (e.g., towards the end portion 28) that is opposite from the first direction 100 along which the socket assembly 20 moves towards the receiving structure 16. As such, the alignment structure 70 is moved into a retracted position. By receiving the receiving structure 16 and moving axially, the alignment structure 70 functions to align the fastener 14 and the threaded portion 18 of the receiving structure 16.

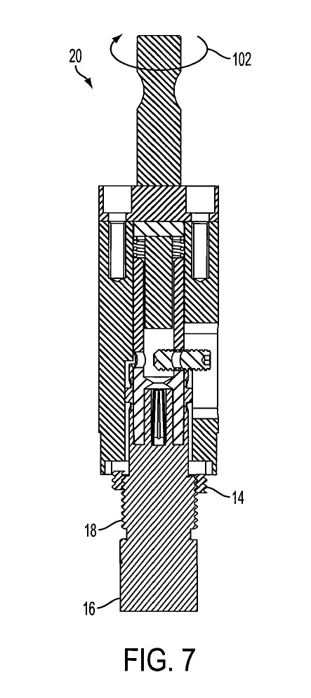

Referring now to FIG. 7, the socket assembly 20 can be rotated in a rotation direction 102. By rotating the socket assembly 20 in the rotation direction 102, the fastener 14 can likewise be rotated and released from the socket assembly 20. This rotation can cause the fastener 14 to be released onto the receiving structure 16 by threadingly engaging the threaded portion 18. The fastener 14 can continue to be rotated, thus causing the fastener 14 to move axially along the threaded portion 18 of the receiving structure 16.

By providing the socket assembly 20 with the alignment structure 70, the socket assembly 20 can be axially aligned with the receiving structure 16. Accordingly, the risk of cross-threading the fastener 14 onto the threaded portion 18 is thereby reduced. Further, the socket assembly 20 can grip and hold the fastener 14 by the non-magnetic means of the gripping structure 58. Since the fasteners 14 can be relatively small, the socket assembly 20 reduces the need for a user to manually pick up the fasteners 14 with his/her fingers and/or with pliers.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A socket assembly for attaching a fastener to a receiving structure, the socket assembly including:
a body portion defining a receiving space;
a gripping structure attached to the body portion, the gripping structure movably supporting the fastener within the receiving space; and
an alignment structure configured to axially align the body portion and the receiving structure.

2. The socket assembly of claim 1, further including a hinge pin extending through the body portion and the gripping structure, the gripping structure being configured to pivot about the hinge pin between an opened position and a closed position.

3. The socket assembly of claim 2, wherein the gripping structure includes a tapered end portion, the tapered end portion being configured to engage the fastener and move the gripping structure.

4. The socket assembly of claim 3, wherein the gripping structure is biased towards the closed position with a grip biasing device.

5. The socket assembly of claim 1, wherein the alignment structure extends axially within the body portion, the alignment structure being axially movable with respect to the body portion between an extended position and a retracted position.

6. The socket assembly of claim 5, further including an alignment biasing device positioned within the body portion.

7. The socket assembly of claim 6, wherein an end of the alignment structure engages the alignment biasing device, the alignment biasing device being configured to bias the alignment structure in an extended position.

8. The socket assembly of claim 1, wherein the receiving space extends axially from an end of the body portion into an interior of the body portion.

9. The socket assembly of claim 8, wherein an axial depth of the receiving space is less than an axial depth of the fastener such that the fastener extends at least partially out of the receiving space when the gripping structure supports the fastener within the receiving space.

10. A socket assembly for attaching a fastener to a receiving structure, the socket assembly including:
a body portion defining a receiving space; and
a gripping structure movably supported by the body portion, the gripping structure being movable between a closed position and an opened position in which an end of the gripping structure is radially spaced away from the receiving space, wherein the gripping structure is configured to support the fastener within the receiving space.

11. The socket assembly of claim 10, further including an alignment structure extending axially within the body portion.

12. The socket assembly of claim 11, wherein the alignment structure is axially movable with respect to the body portion between an extended position and a retracted position.

13. The socket assembly of claim 12, further including an alignment screw for movably attaching the alignment structure to the body portion, the alignment screw extending in a radial direction with respect to the body portion and the alignment structure.

14. The socket assembly of claim 13, wherein the body portion includes an alignment slot for receiving the alignment screw, the alignment structure being configured to move axially with respect to the body portion such that the alignment screw translates within the alignment slot.

15. The socket assembly of claim 10, wherein the end of the gripping structure includes a tapered end portion, the tapered end portion being configured to engage the fastener and move the gripping structure.

16. The socket assembly of claim 15, wherein the gripping structure is biased in the closed position with a grip biasing device.

17. The socket assembly of claim 16, wherein the gripping structure extends axially along the body portion and defines an outer surface of the body portion.

18. A method of attaching a fastener to a receiving structure, the method including the steps of:
gripping the fastener with a socket assembly;
axially aligning the socket assembly and the receiving structure by displacing an alignment structure of the socket assembly axially in a first direction as the socket assembly moves towards the receiving structure in an opposing second direction; and
releasing the fastener from the socket assembly onto the receiving structure.

19. The method of claim 18, wherein the step of gripping the fastener with the socket assembly further includes the step of movably supporting a gripping structure with the body portion and moving the gripping structure between a closed position in which the gripping structure grips the fastener and an opened position in which the fastener is removable from the socket assembly.

20. The method of claim 18, further including the step of rotating the socket assembly such that the fastener threadingly engages the receiving structure.
